(19) United States
(12) Patent Application Publication
(10) Pub. No.: US 2026/0052119 A1
(43) Pub. Date: Feb. 19, 2026

(54) SYSTEMS AND METHODS FOR GENERATING SPOKES USING LARGE LANGUAGE MODELS

(71) Applicant: ServiceNow, Inc., Santa Clara, CA (US)

(72) Inventors: Swati Agarwal, Hyderabad (IN); Lalit Kumar, Hyderabad (IN); Chandra Mouli Kharidehal, Hyderabad (IN); Murali Raj Kamal Addanki, Hyderabad (IN); Swati Sucharita, Hyderabad (IN)

(21) Appl. No.: 18/805,180

(22) Filed: Aug. 14, 2024

(51) Int. Cl. H04L 51/046; G06F 3/0486; H04L 51/02

(52) U.S. Cl. CPC H04L 51/046; G06F 3/0486; H04L 51/02

(57) ABSTRACT

A method includes obtaining, via a spoke generation tool, documentation associated with an external system, where the documentation includes natural language indicative of configuration information for a service provided by the external system, generating, via the spoke generation tool, a list of actions based on the documentation, where the list of actions comprises an action to be performed to access the service, receiving, via the spoke generation tool, an input requesting to modify the list of actions, updating, via the spoke generation tool, the list of actions based on the input, and generating, via the spoke generation tool and based on the updated list of actions, a spoke configured to enable execution of the computing service provided by the external system.

### TECHNICAL FIELD

The present disclosure relates generally to a system and method for creating and executing communication interfaces, and more specifically to enabling such communication interfaces to communicate with application programming interface (API) providers (e.g., third-party service providers) that provide numerous computing services.

### BACKGROUND

This section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

Organizations, regardless of size, rely upon access to information technology (IT) and data and services for their continued operation and success. A respective organization's IT infrastructure may have associated hardware resources (e.g. computing devices, as well as IT infrastructure, such as routers, load balancers, firewalls, switches, etc.) and software resources (e.g. productivity software, database applications, large language models (LLMs), generative artificial intelligence (AI) applications, custom applications, and so forth). Over time, more and more organizations have turned to cloud computing approaches to supplement or enhance their IT infrastructure solutions.

Cloud computing relates to the sharing of computing resources that are generally accessed via the Internet. In particular, a cloud computing infrastructure allows users, such as individuals and/or enterprises, to access a shared pool of computing resources, such as servers, storage devices, networks, applications, and/or other computing-based services. By doing so, users are able to access computing resources on demand that are located at remote locations. These resources may be used to perform a variety of computing functions (e.g., storing and/or processing large quantities of computing data). For enterprise and other organization users, cloud computing provides flexibility in accessing cloud computing resources without accruing large up-front costs, such as purchasing expensive network equipment or investing large amounts of time in establishing a private network infrastructure. Instead, by utilizing cloud computing resources, users are able to redirect their resources to focus on their enterprise's core functions.

In cloud-based architectures, a web browser or native application is often used on the client side to access cloud-based applications and resources. For example, an enterprise or other organization may utilize cloud computing resources offered by application programming interface (API) providers (e.g., third-party service providers) to provide a number of computing services for clients of the enterprise or organization. However, facilitating and/or enabling communication between the enterprise and the API providers can be tedious and time consuming. In certain cases, API providers may include documentation (e.g., specifications) that include distinct configuration details for one or more of the computing services (e.g., remote software applications) provided by the API provider. For example, the specification may define an integration point for a service provided by the API provider, a pagination type associated with responses provided by the integration point, and/or various mappings to items stored in a database. For some API providers, API specifications (e.g., the OpenAPI specification) may be available and can be used to generate communication systems (e.g., software communication systems, spokes) that facilitate communication between the API providers and an enterprise employing the services of the API providers.

However, for many API providers, such an API specification collection (e.g., the OpenAPI specification) is unavailable. Instead, operators tasked with generating communication systems (e.g., spokes) for such API providers may parse through the API documentation (i.e., specification) to identify relevant information for generating the communication system. For example, operators may parse through the documentation and manually configure REST API steps for each service provided by the API provider. Unfortunately, such manual parsing is time consuming and prone to errors, thereby reducing efficacy of the generated communication system. Techniques for enabling communication systems to communicate with API providers in a faster, more efficient, and more accurate and/or reliable manner are needed.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

In an embodiment, a method includes obtaining, via a spoke generation tool, documentation associated with an external system. The documentation includes natural language indicative of configuration information for a service provided by the external system. A list of actions is generated via the spoke generation tool based on the documentation. The list of actions comprises an action to be performed to access the service. An input requesting to modify the list of actions is received via the spoke generation tool. The list of actions is updated via the spoke generation tool based on the input. A spoke configured to enable execution of the computing service provided by the external system is generated via the spoke generation tool and based on the updated list of actions.

In another embodiment, a system processing circuitry and a memory, accessible by the processing circuitry are provided. The memory stores instructions that, when executed by the processing circuitry, cause the processing circuitry to perform operations including: obtaining documentation associated with an external system, where the documentation includes natural language associated with a service provided by the external system; processing the documentation using one or more large language models (LLMs) to identify one or more integration points to access the service; and generating a spoke comprising the one or more integration points, wherein the spoke is configured to enable execution of the service provided by the external system based at least in part on the one or more integration points.

In a further embodiment, a non-transitory, computer-readable medium stores instructions that, when executed by processing circuitry, cause the processing circuitry to: obtain documentation associated with an external system, where the documentation includes natural language associated with a service provided by the external system; generate a list of actions based on the documentation, where the list of actions includes an action to be performed to access the service; receive an input requesting to modify the list of actions; generate an updated list of actions based on the input; and generate, based on the updated list of actions, a spoke configured to enable execution of the computing service provided by the external system.

Various refinements of the features noted above may exist in relation to various aspects of the present disclosure. Further features may also be incorporated in these various aspects as well. These refinements and additional features may exist individually or in any combination. For instance, various features discussed below in relation to one or more of the illustrated embodiments may be incorporated into any of the above-described aspects of the present disclosure alone or in any combination. The brief summary presented above is intended only to familiarize the reader with certain aspects and contexts of embodiments of the present disclosure without limitation to the claimed subject matter.

### BRIEF DESCRIPTION OF THE DRAWINGS

Various aspects of this disclosure may be better understood upon reading the following detailed description and upon reference to the drawings in which:

FIG. 1 is a block diagram of an embodiment of a multi-instance cloud architecture in which embodiments of the present disclosure may operate;

FIG. 2 is a schematic diagram of an embodiment of a multi-instance cloud architecture in which embodiments of the present disclosure may operate;

FIG. 3 is a block diagram of a computing device utilized in a computing system that may be present in FIG. 1 or 2, in accordance with aspects of the present disclosure;

FIG. 4 is a block diagram illustrating a virtual server that supports and enables a client instance, in accordance with aspects of the present disclosure;

FIG. 5 is a screenshot of a GUI for selecting a mode of a spoke generation tool, in accordance with aspects of the present disclosure;

FIG. 6 is a screenshot of a GUI for uploading documentation to an LLM-based generative AI spoke generation tool, in accordance with aspects of the present disclosure;

FIG. 7 is a screenshot of a GUI for generating a list of actions that define a communication interface, in accordance with aspects of the present disclosure;

FIG. 8 is a screenshot of a GUI for reviewing, editing, and/or modifying a communication interface generated by an LLM-based generative AI spoke generation tool, in accordance with aspects of the present disclosure; and

FIG. 9 is a flow chart of a process for generating a communication interface, in accordance with aspects of the present disclosure.

### DETAILED DESCRIPTION

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers'specific goals, such as compliance with system-related and enterprise-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

As used herein, the term “computing system” refers to an electronic computing device that includes, but is not limited to a computer, virtual machine, virtual container, host, server, laptop, and/or mobile device, or to a plurality of electronic computing devices working together to perform the function described as being performed on or by the computing system. As used herein, the term “medium” refers to one or more non-transitory, computer-readable physical media that together store the contents described as being stored thereon. Embodiments may include non-volatile secondary storage, read-only memory (ROM), and/or random-access memory (RAM). As used herein, the term “application” refers to one or more computing modules, programs, processes, workloads, threads and/or a set of computing instructions executed by a computing system. Example embodiments of an application include software modules, software objects, software instances and/or other types of executable code.

Various embodiments disclosed herein are directed to a spoke generation tool (e.g., a wizard system) that builds spokes, based on natural language inputs (i.e., specification documentation in a natural language) provided via the spoke generation tool (e.g., uploaded via the spoke generation tool), using large language models (LLMs). As used herein, the term “spoke”may refer to a software system that is included as a subsystem of an integration hub. The phrase “integration hub” may be defined herein as a software system that may provide for “codeless” development and integration with the aforementioned spokes. More specifically, the integration hub may include or operatively couple with a Flow Designer system that provides “codeless” development of software via natural language and visual information presentation. “Codeless” development may be defined herein as software development where the creator of the software does not use a computer language., e.g., Java, Javascript, C #, and the like. Instead, the creator of the software may use natural language and visual tools to create the software, for example, by designing a flowchart-like process that may take certain inputs and executes certain actions.

The integration hub may utilize the various spokes (e.g., via the Flow Designer system) to create certain automated processes that facilitate communication between the third-party service providers (e.g., remote software applications and/or services offered by the third-party provider) and the enterprise hosting the integration hub (e.g., without having to create code via traditional computer languages). For example, the integration hub (e.g., via the Flow Designer system) may enable actions to be defined that interact with and utilize objects and/or functions provided by one or more remote software applications (e.g., applications and/or services provided by a third-party provider). The remote software applications may be developed and hosted by third-party computing systems different from a computing system (e.g., a remote network management platform) that may execute a workflow (e.g., specific sequence or series of tasks that, when performed, accomplish one or more goals) that calls on the objects and/or functions of the one or more remote software applications. The automated processes may interact with third-party service providers to provide enhanced functionality by accessing any number of services, such as web-based services, that may include weather forecasting services, financial services, information technology (IT) services, engineering services, and the like. That is, the spokes may be utilized to access the services provided by the third-party service providers in a more seamless and efficient manner relative to traditional computing systems.

Interaction between workflows and the remote software applications may be facilitated by the aforementioned spokes. In certain cases, the Flow Designer system and/or integration hub may include or operatively couple to a “wizard. ” As used herein, the wizard may refer to a setup assistant or user interface type that may present a user with a sequence of one or more dialog boxes that aid the user in accomplishing the setup of one or more spokes. The computing system that executes the workflow, the spoke, and the computing systems that execute the remote software applications may each be physically separate and distinct systems. The spoke may serve as an intermediary between the computing system that executes the workflow and the computing systems that execute the remote software applications. Thus, the workflow may transmit, to the spoke, a request for execution of certain functions provided by the remote software applications. The spoke may, in turn, request execution of these certain functions from the remote software applications. Output of the functions may similarly be provided by the remote software applications to the workflow by way of the spoke.

Each API provider (e.g., third-party service provider) may include documentation (e.g., a specification) that defines the attributes of the corresponding API. Namely, the specification may define the objects (e.g., services) accessible by way of the API, the functions invokable by way of the API, the inputs for these functions, and the outputs of these functions, among other possible attributes. As noted above, the spoke generation tools discussed herein may leverage the power of large language models (LLMs) to analyze, parse, and/or process various natural language inputs from the API providers. The natural language inputs may provide information that facilitates communication with the third-party service provider. For example, documentation (e.g., a specification) having natural language inputs may be uploaded to the spoke generation tool, and the spoke generation tool may employ one or more large language models to automatically identify the attributes of the API (e.g., objects, functions, inputs, and outputs accessible by way of the API).

For example, the specification may include data corresponding to a plurality of actions that enable interaction with objects and/or functions of a particular remote software application. The actions may collectively define an interface for the particular remote software application, which may alternatively be referred to as a spoke. For example, each action of a spoke may be configured to receive input values for a function of the remote software application, generate and transmit a request to an API provider that includes therein the input values, receive a response from the API provider, identify output values of the function in the response, and expose the output values to other actions via output variables. Thus, upon receiving the specification, the spoke generation tool (e.g., using the large language models) may parse through the specification and analyze the specification to generate the list of actions that interact with the objects and/or functions (e.g., services) provided by the API provider. That is, the spoke generation tool may leverage LLMs to generate a model of a specification associated with an API provider that a machine (e.g., computer) can understand. As the machine processes the model, a spoke having a list of actions that call on (e.g., access) the objects and/or functions (e.g., services) provided by the API provider may be generated automatically, thereby obviating the need for an operator to manually build a spoke based on information provided in the specification.

Upon generating the list of actions, the spoke generation tool may cause a graphical user interface to display the list of actions for review. The graphical user interface may receive inputs modifying, editing, and/or adding certain aspects to each of the actions, adding additional actions, and/or deleting certain actions before receiving an approval of the spoke. Subsequently, the spoke may be approved for deployment such that enterprises may utilize the spoke to communicate with a corresponding API provider. In this way, time and costs associated with generating a spoke to interface with API providers may be significantly reduced and the accuracy of the spoke may be increased.

Use of the disclosed techniques may result in faster and more computationally efficient creation of spokes (e.g., communication systems) that facilitate connection and/or communication with the various computing services provided by the external systems (e.g., systems external to the client instance on which the spoke generation tool executes) by reducing the amount of time needed for a spoke designer to manually parse through documentation to determine relevant access and/or account details that enable connection and/or access to the services provided by the external systems. Additionally, use of the disclosed techniques may result in the creation of more accurate spokes and/or spokes having fewer errors (e.g., by reducing human hours spent designing spokes, as well as problems with spokes resulting from human error).

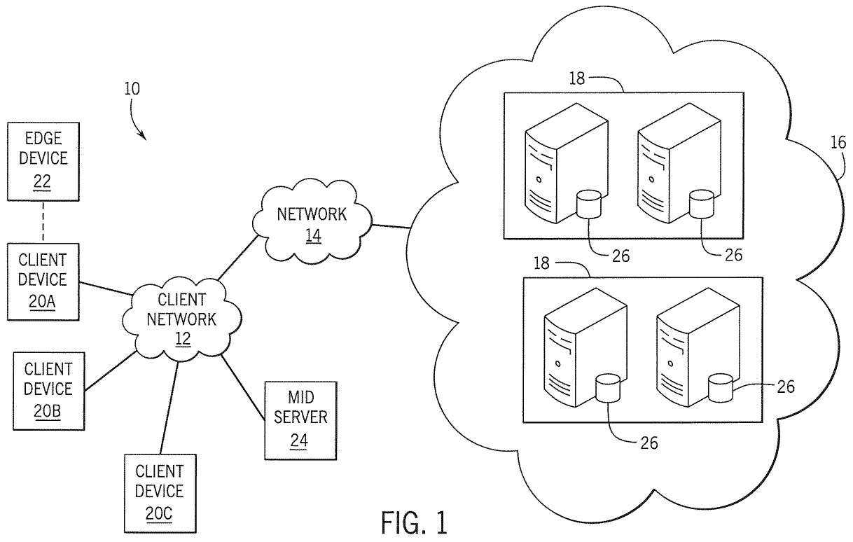

With the preceding in mind, the following figures relate to various types of generalized system architectures or configurations that may be employed to provide services to an organization in a multi-instance framework and on which the present approaches may be employed. Correspondingly, these system and platform examples may also relate to systems and platforms on which the techniques discussed herein may be implemented or otherwise utilized. Turning now to FIG. 1, a schematic diagram of an embodiment of a cloud computing system 10 where embodiments of the present disclosure may operate, is illustrated. The cloud computing system 10 may include a client network 12, a network 14 (e.g., the Internet), and a cloud-based platform 16. In one embodiment, the client network 12 may be a local private network, such as local area network (LAN) having a variety of network devices that include, but are not limited to, switches, servers, and routers. In another embodiment, the client network 12 represents an enterprise network that could include one or more LANs, virtual networks, data centers 18, and/or other remote networks. As shown in FIG. 1, the client network 12 is able to connect to one or more client devices 20A, 20B, and 20C so that the client devices are able to communicate with each other and/or with the network hosting the platform 16. The client devices 20 may be computing systems and/or other types of computing devices generally referred to as Internet of Things (IoT) devices that access cloud computing services, for example, via a web browser application or via an edge device 22 that may act as a gateway between the client devices 20 and the platform 16. FIG. 1 also illustrates that the client network 12 includes an administration or managerial application, device, agent, or server, such as a management, instrumentation, and discovery (MID) server 24 that facilitates communication of data between the network hosting the platform 16, other external applications, data sources, and services, and the client network 12. Although not specifically illustrated in FIG. 1, the client network 12 may also include a connecting network device (e.g., a gateway or router) or a combination of devices that implement a customer firewall or intrusion protection system.

For the illustrated embodiment, FIG. 1 illustrates that client network 12 is coupled to the network 14, which may include one or more computing networks, such as other LANs, wide area networks (WAN), the Internet, and/or other remote networks, to transfer data between the client devices 20 and the network hosting the platform 16. Each of the computing networks within network 14 may contain wired and/or wireless programmable devices that operate in the electrical and/or optical domain. For example, network 14 may include wireless networks, such as cellular networks (e.g., Global System for Mobile Communications (GSM) based cellular network), IEEE 802.11 networks, and/or other suitable radio-based networks. The network 14 may also employ any number of network communication protocols, such as Transmission Control Protocol (TCP) and Internet Protocol (IP). Although not explicitly shown in FIG. 1, network 14 may include a variety of network devices, such as servers, routers, network switches, and/or other network hardware devices configured to transport data over the network 14.

In FIG. 1, the network hosting the platform 16 may be a remote network (e.g., a cloud network) that is able to communicate with the client devices 20 via the client network 12 and network 14. The network hosting the platform 16 provides additional computing resources to the client devices 20 and/or the client network 12. For example, by utilizing the network hosting the platform 16, users of the client devices 20 are able to build and execute applications and/or workflows for various enterprise, IT, and/or other organization-related functions. In one embodiment, the network hosting the platform 16 is implemented on the one or more data centers 18, where each data center could correspond to a different geographic location. Each of the data centers 18 includes a plurality of virtual servers 26 (also referred to herein as application nodes, application servers, virtual server instances, application instances, or application server instances), where each virtual server 26 can be implemented on a physical computing system, such as a single electronic computing device (e.g., a single physical hardware server) or across multiple-computing devices (e.g., multiple physical hardware servers). Examples of virtual servers 26 include, but are not limited to a web server (e.g., a unitary Apache installation), an application server (e.g., unitary JAVA Virtual Machine), and/or a database server (e.g., a unitary relational database management system (RDBMS) catalog).

It would be beneficial to integrate the virtual servers 26 with external systems, such as systems 28 (e.g., third-party providers, remote API providers). The systems 28 may provide, for example, a number of web-based services that may be accessible via various messaging protocols (e.g., simple object access protocol (SOAP)) that enable software running on disparate operating systems to communicate using Hypertext Transfer Protocol (HTTP) and its Extensible Markup Language (XML). The techniques described in further detail below may enable the creation of spokes (e.g., software communication systems, communication interfaces), suitable for providing and/or facilitating communication between the servers 26 and the external systems 28. Accordingly, web-based services such as weather forecasting services, financial services, information technology (IT) services, and so on, may be accessed from the virtual servers 26.

To utilize computing resources within the platform 16, network operators may choose to configure the data centers 18 using a variety of computing infrastructures. In one embodiment, one or more of the data centers 18 are configured using a multi-tenant cloud architecture, such that one of the server instances 26 handles requests from and serves multiple customers. Data centers 18 with multi-tenant cloud architecture commingle and store data from multiple customers, where multiple customer instances are assigned to one of the virtual servers 26. In a multi-tenant cloud architecture, the particular virtual server 26 distinguishes between and segregates data and other information of the various customers. For example, a multi-tenant cloud architecture could assign a particular identifier for each customer in order to identify and segregate the data from each customer. Generally, implementing a multi-tenant cloud architecture may suffer from various drawbacks, such as a failure of a particular one of the server instances 26 causing outages for all customers allocated to the particular server instance.

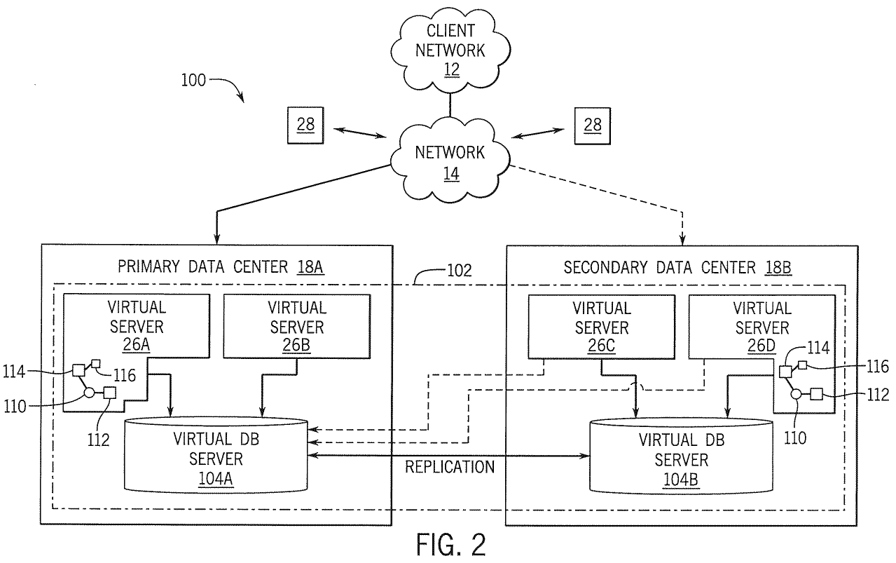

In another embodiment, one or more of the data centers 18 are configured using a multi-instance cloud architecture to provide every customer its own unique customer instance or instances. For example, a multi-instance cloud architecture could provide each customer instance with its own dedicated application server(s) and dedicated database server(s). In other examples, the multi-instance cloud architecture could deploy a single physical or virtual server 26 and/or other combinations of physical and/or virtual servers 26, such as one or more dedicated web servers, one or more dedicated application servers, and one or more database servers, for each customer instance. In a multi-instance cloud architecture, multiple customer instances could be installed on one or more respective hardware servers, where each customer instance is allocated certain portions of the physical server resources, such as computing memory, storage, and processing power. By doing so, each customer instance has its own unique software stack that provides the benefit of data isolation, relatively less downtime for customers to access the platform 16, and customer-driven upgrade schedules. An example of implementing a customer instance within a multi-instance cloud architecture will be discussed in more detail below with reference to FIG. 2.

FIG. 2 is a schematic diagram of an embodiment of a multi-instance cloud architecture 100 where embodiments of the present disclosure may operate. FIG. 2 illustrates that the multi-instance cloud architecture 100 includes the client network 12 and the network 14 that connect to two (e.g., paired) data centers 18A and 18B that may be geographically separated from one another and provide data replication and/or failover capabilities. Using FIG. 2 as an example, network environment and service provider cloud infrastructure client instance 102 (also referred to herein as a client instance 102) is associated with (e.g., supported and enabled by) dedicated virtual servers (e.g., virtual servers 26A, 26B, 26C, and 26D) and dedicated database servers (e.g., virtual database servers 104A and 104B). Stated another way, the virtual servers 26A-26D and virtual database servers 104A and 104B are not shared with other client instances and are specific to the respective client instance 102. In the depicted example, to facilitate availability of the client instance 102, the virtual servers 26A-26D and virtual database servers 104A and 104B are allocated to two different data centers 18A and 18B so that one of the data centers 18 acts as a backup data center. Other embodiments of the multi-instance cloud architecture 100 could include other types of dedicated virtual servers, such as a web server. For example, the client instance 102 could be associated with (e.g., supported and enabled by) the dedicated virtual servers 26A-26D, dedicated virtual database servers 104A and 104B, and additional dedicated virtual web servers (not shown in FIG. 2).

In the depicted embodiment, an integration hub 110 (e.g., integration hub system) may be operatively coupled to or include a Flow Designer system 112. The integration hub 110 may enable the execution of third-party application programming interfaces (APIs), including objects, automated processes, and so on, such as APIs included in the external systems 28. More specifically, the integration hub 110 may enable the creation of one or more spokes 114 suitable for interfacing with the external systems 28. For example, automation processes created by the Flow Designer system 112 may use the spokes 114 to interface with the external systems 28.

In the depicted embodiment, a wizard system 116 (e.g., spoke generation tool) may be used to create the spokes 114. That is, a user of the integration hub 110 and/or the Flow Designer system 112 may be guided by the wizard system 116 to enter certain information, described in further detail below, suitable for interacting with services provided by the external systems 28. The wizard system 116 may collaborate with the integration hub 10 to provide for a more efficient creation of a customized or configured application (e.g., a scoped application) on a development instance of the servers 26 to build the spokes 114. The spokes 114 may then be published in an application repository. The application repository may then be used to create a test server instance running the scoped application. Accordingly, the application may be more easily tested, modified, and/or edited before being deployed. Once testing is complete, the application may be published in various ways, such as publishing to production instances of the servers 26, to online application stores, and/or via sharing facilities.

Although FIGS. 1 and 2 illustrate specific embodiments of a cloud computing system 10 and a multi-instance cloud architecture 100, respectively, this disclosure is not limited to the specific embodiments illustrated in FIGS. 1 and 2. For instance, although FIG. 1 illustrates that the platform 16 is implemented using data centers, other embodiments of the platform 16 are not limited to data centers and can utilize other types of remote network infrastructures. Moreover, other embodiments of the present disclosure may combine one or more different virtual servers into a single virtual server or, conversely, perform operations attributed to a single virtual server using multiple virtual servers. For instance, using FIG. 2 as an example, the virtual servers 26A, 26B, 26C, 26D and virtual database servers 104A, 104B may be combined into a single virtual server. Moreover, the present approaches may be implemented in other architectures or configurations, including, but not limited to, multi-tenant architectures, generalized client/server implementations, and/or even on a single physical processor-based device configured to perform some or all of the operations discussed herein. Similarly, though virtual servers or machines may be referenced to facilitate discussion of an implementation, physical servers may instead be employed as appropriate. The use and discussion of FIGS. 1 and 2 are only examples to facilitate ease of description and explanation and are not intended to limit the disclosure to the specific examples illustrated therein.

As may be appreciated, the respective architectures and frameworks discussed with respect to FIGS. 1 and 2 incorporate computing systems of various types (e.g., servers, workstations, client devices, laptops, tablet computers, cellular telephones, edge devices, and so forth) throughout. For the sake of completeness, a brief, high level overview of components typically found in such systems is provided. As may be appreciated, the present overview is intended to merely provide a high-level, generalized view of components typical in such computing systems and should not be viewed as limiting in terms of components discussed or omitted from discussion.

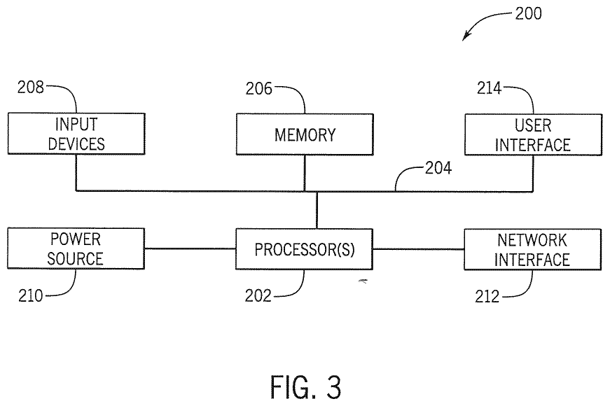

With this in mind, and by way of background, it may be appreciated that the present approach may be implemented using one or more processor-based systems such as shown in FIG. 3. Likewise, applications and/or databases utilized in the present approach may be stored, employed, and/or maintained on such processor-based systems. As may be appreciated, such systems as shown in FIG. 3 may be present in a distributed computing environment, a networked environment, or other multi-computer platform or architecture. Likewise, systems such as that shown in FIG. 3, may be used in supporting or communicating with one or more virtual environments or computational instances on which the present approach may be implemented.

With this in mind, an example computing system 200 may include some or all of the computer components depicted in FIG. 3. FIG. 3 generally illustrates a block diagram of example components of a computing system 200 and their potential interconnections or communication paths, such as along one or more busses. As illustrated, the computing system 200 may include various hardware components such as, but not limited to, one or more processors 202 (e.g., processing circuitry), one or more busses 204, memory 206, input devices 208, a power source 210, a network interface 212, a user interface 214, and/or other computer components useful in performing the functions described herein.

The one or more processors 202 may include one or more microprocessors capable of performing instructions stored in the memory 206. Additionally or alternatively, the one or more processors 202 may include application-specific integrated circuits (ASICs), field-programmable gate arrays (FPGAs), and/or other devices designed to perform some or all of the functions discussed herein without calling instructions from the memory 206.

With respect to other components, the one or more busses 204 include suitable electrical channels to provide data and/or power between the various components of the computing system 200. The memory 206 may include any tangible, non-transitory, and computer-readable storage media. Although shown as a single block in FIG. 1, the memory 206 can be implemented using multiple physical units of the same or different types in one or more physical locations. The input devices 208 correspond to structures to input data and/or commands to the one or more processors 202. For example, the input devices 208 may include a mouse, touchpad, touchscreen, keyboard and the like. The power source 210 can be any suitable source for power of the various components of the computing device 200, such as line power and/or a battery source. The network interface 212 includes one or more transceivers capable of communicating with other devices over one or more networks (e.g., a communication channel). The network interface 212 may provide a wired network interface or a wireless network interface. A user interface 214 may include a display that is configured to display text or images transferred to it from the one or more processors 202. In addition and/or alternative to the display, the user interface 214 may include other devices for interfacing with a user, such as lights (e.g., LEDs), speakers, and the like.

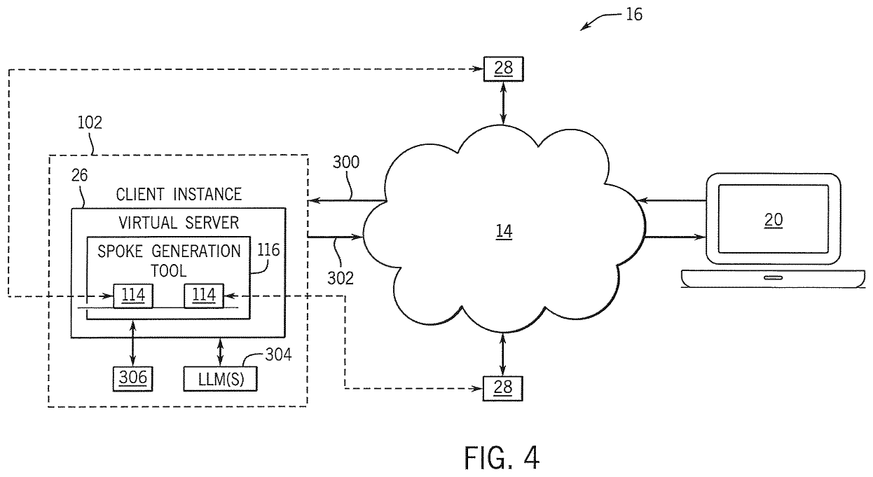

With the preceding in mind, FIG. 4 is a block diagram illustrating an embodiment in which a virtual server 26 supports and enables the client instance 102, according to one or more disclosed embodiments. More specifically, FIG. 4 illustrates an example portion of a service provider cloud infrastructure, including the cloud-based platform 16 discussed above. The cloud-based platform 16 is connected to a client device 20 via the network 14 to provide a user interface to network applications executing within the client instance 102 (e.g., via a web browser or a native application running on the client device 20). Client instance 102 is supported by virtual servers 26 similar to those explained above with respect to FIG. 2, and is illustrated here to show support for the disclosed functionality described herein within the client instance 102. Cloud provider infrastructures are generally configured to support a plurality of end-user devices, such as client device(s) 20, concurrently, wherein each end-user device is in communication with the single client instance 102. Also, cloud provider infrastructure may be configured to support any number of client instances, such as client instance 102, concurrently, with each of the instances in communication with one or more end-user devices. As mentioned above, an end-user may also interface with client instance 102 using an application that is executed within a web browser.

As shown, the client device 20 may interact with the client instance 102 by providing inputs 300, to which the client instance 102 may respond with outputs 302. In the embodiment shown in FIG. 4, the virtual server 26 of the client instance 120 may run the wizard system 116 (e.g., spoke generation tool), which may be a software application defined by code, accessible via a native application or web browser of the client device 20. The spoke generation tool 116 may be configured to generate the spokes 114 that facilitate communication between the client instance 102 and the external systems 28, thereby enabling the client instance 102 to return outputs 302 to the client device 20 that call on respective outputs and/or functions (e.g., actions) of the external systems 28. For example, the inputs 300 may include inputs requesting a particular output and/or function from the external systems 28. Correspondingly, the outputs 302 may include the requested output and/or function from the external systems 28, responses to other inputs 300, questions, and so forth.

In certain embodiments, the spoke generation tool 116 may utilize one or more large language models 304 (LLMs), which may be stored within the client instance 102 or accessible to the client instance 102, to generate the spokes 114. As used herein, a large language model (LLM) is a probabilistic model of a natural language used for general-purpose language generation. LLMs typically include one or more artificial neural networks having a transformer-base architecture. LLMs learn statistical relationships from text documents through training processes that may be supervised, semi-supervised, or self-supervised. During training, LLMs may learn syntax, semantics, and/or ontology. LLMs, when used for text generation, receive an input text and iteratively predict the next word or token. It should be understood that the client instance 102 shown in FIG. 4 may be utilized by the client device 20 for other tasks, as well as tasks beyond the scope of spoke generation and/or modification.

Traditionally, enabling communication between a remote network management platform (e.g., remote network management platform 16, virtual servers 26) and remote software applications hosted by external systems 28 external to the remote network management platform (e.g., generating and/or modifying software communication systems (i.e., spokes 114) that facilitate communication with the external systems 28) has been tedious and time consuming. For example, each external system 28 may have corresponding documentation (e.g., API documentation, a specification) that identifies and/or defines a number of attributes of the external system 28 (e.g., services provided by the external systems 28, connection points to the services provided by the external systems 28, configuration details for the external systems 28, and so forth). The documentation may also include other details associated with the external systems 28 (e.g., authentication details) and/or other information that may not be directly associated with accessing the services provided by the external systems 28. That is, the documentation may include large amounts of data, some of which may be more relevant in facilitating communication with the external system 28 relative to other portions of data. Traditionally, operators may be tasked with manually parsing through such large amounts of data to identify relevant portions, thereby enabling the operators to manually configure steps (e.g., REST API steps) for each service provided by the external system 28. Unfortunately, such manual parsing is time consuming and prone to errors, thereby reducing efficacy of a manually generated spoke.

The presently disclosed spoke generation tool 116 receives (e.g., via an upload) natural language inputs corresponding to a specification of a respective external system 28, and uses the LLMs 304 to automatically build the spokes 114 based on the natural language inputs. As used herein, “natural language” is intended as language, either written, typed, or spoken by a human being. Accordingly, a natural language input may be one or more human-readable alphanumeric character strings, or audio, the meaning of which may be understood by a human.

The spoke generation tool 116 may receive documentation 306 (e.g., a specification) having natural language inputs and may utilize the LLMs 304 to parse through (e.g., analyze) the documentation 306, thereby enabling the generation of respective spokes 114 configured to facilitate communication between the client instance 102 (e.g., virtual server 26) and the external systems 28. The documentation 306 may be a file, database table(s), or set of associations that includes account information details (e.g., passwords, usernames) and access details for computing services offered by external systems 28. For instance, given that a particular computing service may be accessed through an integration point, such as an API endpoint, the documentation 306 may contain a list of API endpoints for computing services. In examples, these API endpoints may include representational state transfer (REST) APIs, Simple Object Access Protocol (SOAP) APIs, GraphQL APIs, or other types of API architectures. Additionally, the documentation 306 may include one or more mappings between descriptions of the computing services offered by the external systems 28 and configuration items stored in a database.

Thus, the documentation 306 may include data corresponding to a plurality of actions that enable interaction with one or more objects and/or functions of a particular remote software application (e.g., list of API endpoints, list of integration points, mappings, and the like). For example, each action of a spoke 114 may be configured to receive input values for a function of the remote software application, generate and transmit a request to the external system 28 that includes therein the input values, receive a response from the external system 28, identify output values of the function in the response, and expose the output values to other actions via output variables. It should be appreciated that the documentation 306 received by the spoke generation tool 114 may correspond to a list of actions that define a single service associated with a particular remote software application of an external system 28, a list of actions that define a variety of services associated with a particular remote software application of an external system 28, or a list of actions that define a variety of services associated with a variety of remote software applications of an external system 28. Thus, the generated spokes 114 may enable communication with a single service of a single remote software application, a number of services of a remote software application, or a number of services of an external system 28.

Upon receiving the documentation 306, the spoke generation tool 116 (e.g., using the LLMs 304) may parse through the documentation 306 to generate a list of actions that interact with the objects and/or functions (e.g., services) provided by the external systems 28. That is, the spoke generation tool 116 may leverage the LLMs 304 to generate a model of a specification associated with an external system 28 that a machine (e.g., a computer, the client instance 102, the virtual server 26) can understand. As the machine processes the model, a spoke 114 having a list of actions (e.g., REST steps) that call on (e.g., access) the objects and/or functions (e.g., services) provided by the external system 28 may be generated automatically. In this way, the need for an operator to manually build a spoke based on information provided in the documentation 306 may be obviated, thereby increasing efficiency and reducing errors associated with such manual processing.

In certain embodiments, the spokes 114 generated by the spoke generation tool 116 may be presented (e.g., via a graphical user interface (GUI)) for editing and/or modification before being deployed. For example, the spoke generation tool 116 may cause a GUI to display the list of actions that collectively define the spoke 114. The GUI may also be configured to receive inputs to modify, edit, and/or add certain actions before the spoke 114 is published. The list of actions may be sent for approval (e.g., to an administrator), and upon receiving approval, the spoke 114 may be deployed, thereby enabling the client instance 102 to communicate with the external systems 28. For example, as shown in FIG. 4, the spokes 114 generated by the spoke generation tool 116 may enable the virtual server 26 to communicate with the external systems 28 such that output values of the respective functions and/or objects of the remote software applications may be transmitted as outputs 302 to the client device 20. In certain embodiments, the outputs 302 may be transmitted by way of a native application (e.g., a corresponding client-side version of the spoke generation tool 116) or a web browser.

In certain embodiments, the one or more LLMs 304 may be trained, for example, on existing workflows (e.g., within the enterprise, across an industry, across multiple industries, etc.), business process model and notation (BPMN) conventions, industry standard operating procedures, best industry practices, publicly available information, publications, data from the Internet, and so forth. In some embodiments, the one or more LLMs may be “off the shelf” or “out of the box” LLMs 304 provided by a service provider not unique to the client instance 102. However, in other embodiments, the LLMs 304 may be customized to the client instance 102, either with specific training, specific customized settings, or both.

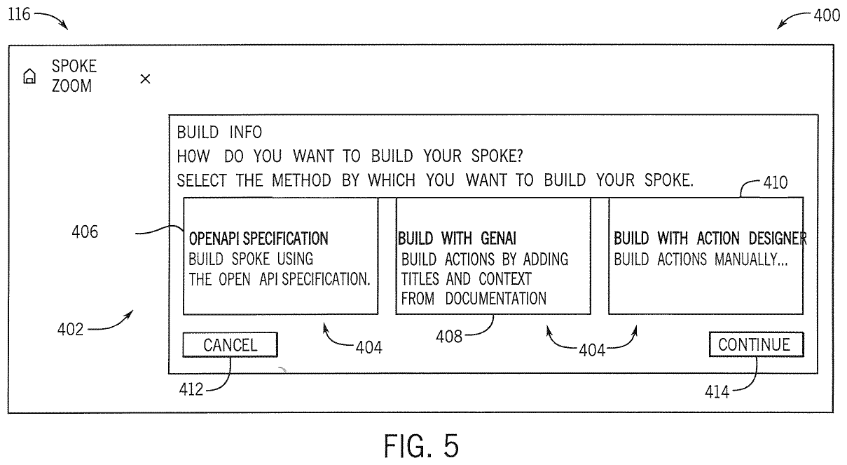

With the foregoing in mind, FIGS. 5-8 represent example screenshots of GUIs that may be displayed via a client device during creation of a new spoke 114. It should be understood, however, that the screenshots depicted in FIGS. 5-8 are merely examples and that embodiments having different GUIs are envisaged. Specifically, FIG. 5 is a screenshot of a GUI 400 for selecting a particular mode of the spoke generation tool 116. As illustrated, the GUI 400 for selecting a particular mode of the spoke generation tool 116 includes a mode window 402 displaying one or more selectable options 404 for generating a spoke 114. For example, a first option 406 (e.g., OpenAPI specification spoke generation tool), when selected, uses OpenAPI specification to generate the spokes 114. A second option 408, when selected, uses GenAI (e.g., an LLM-based generative artificial intelligence spoke generation tool that utilizes the one or more LLMs 304 discussed herein) to generate the spokes 114. A third option 410, when selected, allows a spoke 114 to be built manually from scratch. The window 402 may also include a cancel button 412 to close the GUI 400 without creating a new spoke 114, and a continue button 414 to enable execution of a selected option 404 (e.g., enable generation of a spoke 114 via a selected mode). Though the present disclosure is mostly directed to using the LLM-based generative AI capabilities of the spoke generation tool 116 to generate the spokes 114, it should be understood that the spoke generation tool 116 may also be used to build spokes 114 using other methods (e.g., OpenAPI specification, manual from scratch).

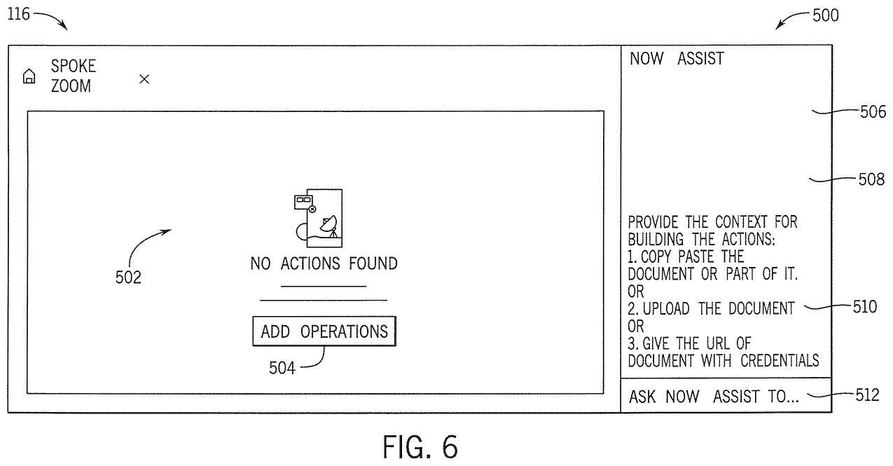

Upon selecting the second option 408, a GUI may be presented that enables a user to upload the documentation 306 that may define the spoke 114. For example, FIG. 6 is a screenshot of a GUI 500 corresponding to the LLM-based generative AI spoke generation tool 116. As shown, the GUI 500 includes a documentation window 502 in which documentation 306 (e.g., an input describing one or more steps that facilitate communication with the services offered by the external systems 28) is provided. For example, the documentation window 502 may include an operations button 504 (e.g., input option) that, when selected, enables a user to upload documentation 306 (e.g., select a file corresponding to the documentation) to the spoke generation tool 116. In certain embodiments, the documentation window 502 may be configured to receive, as input, documentation 306 that has been dragged and dropped (e.g., grab, drag, and drop inputs) from windows external to the documentation window 502.

The GUI 500 may also include an assistance window 506 (e.g., LLM-based generative AI assistance window, interactive chat window) to facilitate the generation of the spokes 114. For example, the assistance window 506 may include a chat interface 508 and may utilize the one or more LLMs 304 to facilitate a chat session with a spoke designer profile, thereby enabling the spoke generation tool 116 to generate messages and/or notifications 510. The spoke generation tool 116 (e.g., via the assistance window 506) may ask how it can help, provide examples of its capabilities, and/or provide prompts for certain actions and/or inputs. For example, the assistance window 506 may display (e.g., via the chat interface 508) a notification 510 (e.g., recommendation) that a user provide context for building a list of actions (e.g., provide the documentation 306) via copying and pasting the documentation 306, uploading the documentation 306, or providing a URL of the documentation 306 (e.g., with credentials). The assistance window 506 may also include an input option 512 that enables a user to input the documentation 306 and/or ask questions. For example, in certain embodiments, the LLMs 304 discussed herein may be utilized to generate responses to a user's questions and/or concerns.

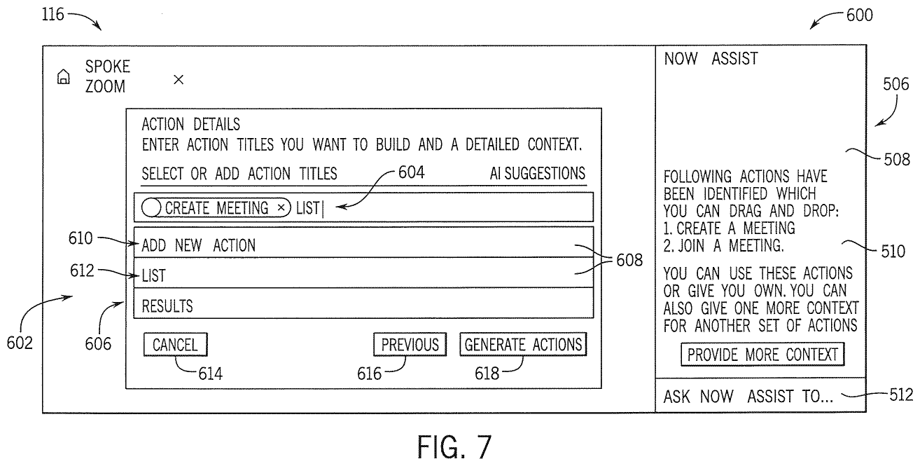

Assuming that the submitted documentation 306 includes data corresponding to steps that enable connection and/or communication with the external systems 28 (e.g., list of actions, REST steps that facilitate access to the services offered by the external systems 28), the LLM-based generative AI spoke generation tool 116 may receive the documentation 306 and generate the list of actions that ultimately define the spoke 114. For example, FIG. 7 is a screenshot of a GUI 600 for generating the list of actions that define a respective spoke 114. As shown, the GUI 600 includes an action details window 602 having an input field 604 for inputting actions that define a spoke 114. For example, a user may input action titles and may provide context (e.g., configurable REST steps that communicate with the applications of the external systems 28) to define a respective spoke 114 via the input field 604. Additionally or alternatively, a drop-down menu 606 may be presented having a number of options 608 available for selection. For example, a first option 610 may correspond to an “add new action” option 610 that, when selected, enables a user to manually input actions (e.g., titles and/or context of an action) for a particular spoke 114 (e.g., via the input field 604). A second option 612 may correspond to an “add List” option 612. The “List” displayed in the second option 612 may correspond to the list of actions that are automatically generated by the spoke generation tool 116 (e.g., LLM-based generative AI spoke generation tool) based on the documentation 306 provided via the GUI 500 discussed above. The action details window 602 may also include a cancel button 614 to close the GUI 600 without generating the list of actions, a previous button 616 to return to previous actions and/or steps performed within the GUI 600, and a generate actions button 618 to generate the list of actions.

In certain embodiments, the GUI 600 may also include the assistance window 506 discussed above with respect to FIG. 6. The assistance window 506 may include the chat interface 508 having the messages and/or notifications 510 that provide suggestions (e.g., using the LLMs 304) to a user. For example, the assistance window 506 may display (e.g., via the chat interface 508) a notification that certain actions have been identified, which can be dragged and dropped into the action details window 602. Additionally or alternatively, the notification may notify the user that additional context may be provided for the identified actions and/or another set of actions (e.g., via the input option 512).

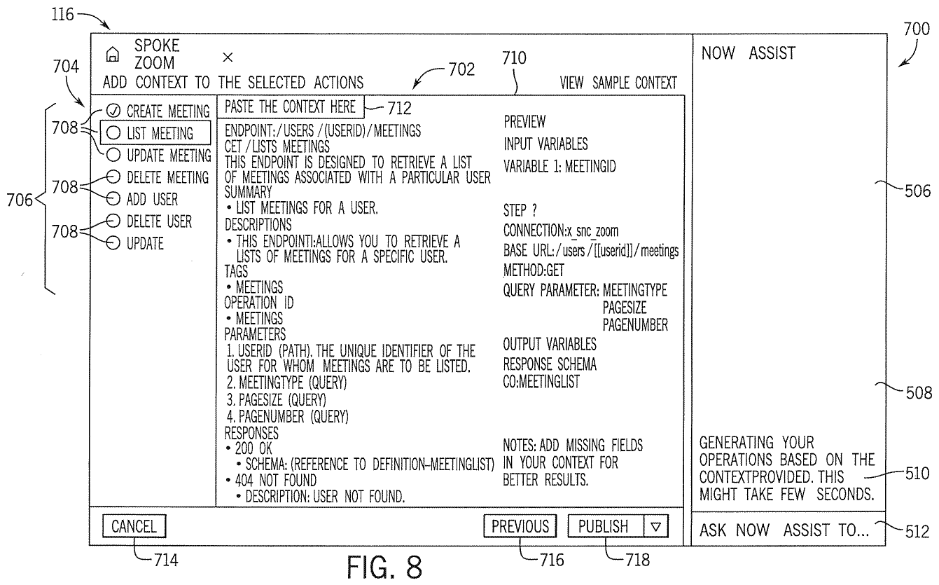

FIG. 8 is a screenshot of a GUI 700 for reviewing, editing, and/or modifying a spoke 114 (e.g., reviewing, editing, and/or modifying actions of a spoke 114) generated by the LLM-based generative AI spoke generation tool in response to receiving the documentation 306 (e.g., via the GUI 500) and/or in response to generating the list of actions (e.g., via the GUI 600). As shown, the GUI 700 may include an actions window 702 for displaying, editing, reviewing, and/or modifying the actions of a spoke 114. For example, the actions window 702 may include a first pane 704 displaying a list of actions 706. The list of actions 706 may include any number of actions 708 (e.g., REST steps) that facilitate connection and/or communication with a particular service of a remote software application of an external system 28. The actions window 702 may also include an edit pane 710 for reviewing, editing, and/or modifying a particular action 708 of the list of actions 706. For example, upon receiving a selection of a particular action 708 within the list of actions 706, the edit pane 710 may be populated with the information that defines the selected action 708 (e.g., configuration information that identifies endpoints that access the services provided by an external system 28, description information that identifies functions of a particular action, identification tags, authentication information, input and output parameters (e.g., page size, pagination type, etc.), input variables, REST steps, and the like). As shown, the “List Meeting” action 708 has been selected, and thus, the edit pane 710 is populated with information pertaining to the “List Meeting”action 708.

The edit pane 710 may also be configured to receive user inputs that edit, modify, and/add certain information to the selected action 708. For example, the edit pane 710 may include an input section 712 that allows inputs to be provided (e.g., via copy and pasting the context). Additionally or alternatively, the edit pane 710 may enable a spoke designer to edit and/or modify information presented in the edit pane 710 directly. For example, a spoke designer may change an action name, an action endpoint, an action definition, REST steps that define the action, parameters of the action, input variables of the action, output variables of the action, and the like by deleting, modifying, and/or adding information directly into the edit pane 710. By further defining the actions, the spokes 114 may be fully defined and deployed, thereby enabling efficient connection and communication between client devices 20 and external systems 28. It should be appreciated that the information associated with the selected action 708 displayed in FIG. 8 is merely an example and that embodiments are envisaged in which the edit pane 710 includes different fields and/or shows data in a different way.

In certain embodiments, the GUI 700 may also include the assistance window 506 discussed above with respect to FIGS. 6 and 7. The assistance window 506 may include the chat interface 508 having the messages and/or notifications 510 that provide suggestions (e.g., using the LLMs 304) to a user (e.g., notifying a user that certain operations are being generated based on provided context). In certain embodiments, the GUI 700 may also include a cancel button 714 to close the GUI 700 without generating the spoke 114, a previous button 716 to enable a user to return to a previous action within the GUI 700, and a publish button 718. For example, once the spoke 114 has been reviewed, the publish button 718 may be selected to finalize the spoke 114 and turn the spoke 114 into an approved spoke ready for deployment. In this way, clients (e.g., via client devices 20) may interface with the external systems 28 (e.g., via the spokes 114) in a seamless and efficient manner.

It should be appreciated that as the spokes 114 are being reviewed and actions of the spokes 114 are being defined and/or added, the spoke generation tool 116 may generate recommendations for adding actions, replacing existing actions, modifying existing actions, and so forth. Such recommendations may be provided in the assistance window 506 shown in FIGS. 6-8. Recommended activities may be determined using an LLM trained on existing spokes 114, business data, BPMN, industry standard operating procedures, a curated set or library of actions and/or REST steps, and so forth.

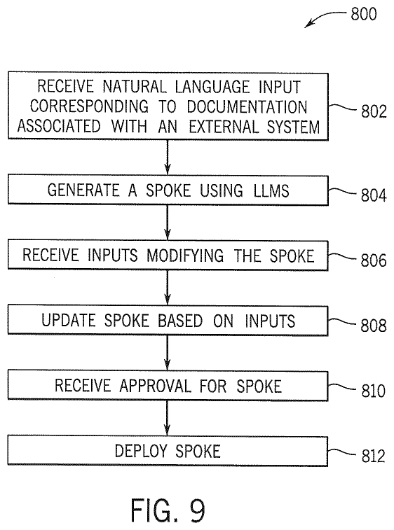

FIG. 9 is a flow chart of a process 800 for generating a spoke 114. At block 802, the process 800 receives a natural language input corresponding to documentation 306 associated with an external system 28. The documentation 306 may include data and/or information corresponding to a list of actions that collectively define a spoke 114. For example, the documentation 306 may include information corresponding to a plurality of REST steps that identify connection points and/or facilitate communication with services offered by the external systems 28.

At Block 804, the process 800 uses one or ore LLMs to generate a spoke 114 populated with a list of actions based on the received documentation 306. The process 800 may use the one or more LLMs to build the spoke action by action. Whereas traditional systems receiving documentation may require a spoke designer (e.g., a human) to manually parse through the documentation to identify relevant information that may be useful in accessing the services provided by the external systems, use of the LLMs 304 discussed herein may enable more efficient processing and analysis of the documentation. That is, the LLMs 304 discussed herein may be trained to identify relevant configuration information, endpoint information, integration point information, and the like within the documentation, thereby resulting in faster, more efficient creation of spokes. Additionally, by reducing human hours spent designing spokes, problems associated with human error may be reduced, thereby resulting in more accurate spokes and/or spokes having fewer errors. The LLMs may be trained on existing spokes 114 (e.g., within the enterprise, across an industry, across multiple industries, etc.) business process model and notation (BPMN) conventions, industry standard operating procedures, industry best practices, publicly available information, publications, data from the Internet, and so forth. In some embodiments, the one or more LLMs may be “off the shelf” or “out of the box” LLMs provided by a service provider and not unique to the client instance. However, in other embodiments, the LLMs may be customized to the client instance, either with specific training, specific customized settings, or both.

At block 806, the process 800 may receive inputs modifying the spoke 114. For example, the process 800 may receive inputs requesting modifications to or making edits to the spoke 114, and/or providing feedback to the spoke generation tool 116. Such modifications may include defining or editing properties of the actions identified and/or generated at block 804. As described above, the spoke generation tool 116 may use the assistance window 506 (e.g., chat interface 508) to make recommendations to modify the spoke and/or receive feedback from a spoke designer profile.

At block 808, the spoke 114 is updated based on the inputs received. Receiving feedback/modifications and updating the spoke 114 may continue iteratively until the spoke 114 is fully defined and/or approval is received (block 810, e.g., from a spoke designer profile).

If the spoke 114 is approved, the process 800 proceeds to block 812 and generates a fully defined and operational spoke 114. If the spoke has not been approved, the process 800 returns to block 806 and receives additional inputs modifying the spoke 114.

The presently disclosed techniques are directed to a spoke generation tool that builds spokes (e.g., software communication systems) based on natural language inputs provided via the spoke generation tool, using large language models (LLMs). Specifically, a natural language input (e.g., documentation corresponding to a specification) that defines the attributes of a respective API may be provided (e.g., uploaded) to the spoke generation tool, and the spoke generation tool may generate a list of actions that define a spoke configured to facilitate communication with the respective API. The spoke generation tool utilizes one or more LLMs to generate the spoke, and the one or more LLMs may be trained on existing spokes (e.g., within the enterprise, across an industry, across multiple industries, etc.), business process model and notation (BPMN) conventions, industry standard operating procedures, industry best practices, publicly available information, publications, data from the Internet, and so forth.

A spoke generated by the spoke generation tool (e.g., list of actions that collectively define a spoke) may be displayed via the spoke generation tool, which may receive inputs making edits to the spoke and/or providing feedback to the spoke generation tool. In further embodiments, the spoke generation tool may include a chat interface by which feedback on the spoke may be provided in natural language. The spoke generation tool uses the one or more LLMs to make changes to the spokes based on the feedback provided.

Technical effects of the disclosed techniques may include lower processor utilization and reduced computational costs associated with less time spent designing spokes and improved efficiency stemming from fewer manually defined spokes. Further, deployment of the presently disclosed techniques may reduce human hours spent designing spokes, as well as problems with spokes resulting from human error.

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S. C. 112(f). However, for any claims containing elements designated in any other manner, it is intended that such elements are not to be interpreted under 35 U.S. C. 112(f).

1. A method comprising:
obtaining, via a spoke generation tool, documentation associated with an external system, wherein the documentation comprises natural language indicative of configuration information for a service provided by the external system;
generating, via the spoke generation tool, a list of actions based on the documentation, wherein the list of actions comprises an action to be performed to access the service;
receiving, via the spoke generation tool, an input requesting to modify the list of actions;
updating, via the spoke generation tool, the list of actions based on the input; and
generating, via the spoke generation tool and based on the updated list of actions, a spoke comprising a communication interface configured to enable execution of the service provided by the external system.

2. The method of claim 1, comprising:
receiving, via a cloud-based instance on which the spoke generation tool executes, a request to access the service of the external system from a client device;
accessing, via the spoke, the service of the external system; and
returning, via the cloud-based instance, execution results corresponding to the request to the client device.

3. The method of claim 1, wherein generating the list of actions comprises using one or more large language models (LLMs), wherein the one or more LLMs are configured to analyze the documentation for data corresponding to the list of actions.

4. The method of claim 3, comprising training the one or more LLMs using one or more business process model and notation (BPMN) conventions, one or more industry standard operating procedures, one or more best industry practices, one or more publications, or any combination thereof.

5. The method of claim 1, comprising:
displaying, via a chat interface of the spoke generation tool, one or more recommendations pertaining to the spoke, wherein the chat interface utilizes the LLMs to generate the one or more recommendations.

6. The method of claim 1, wherein receiving the input comprises:
receiving a manual input from a spoke designer modifying the list of actions.

7. The method of claim 1, wherein obtaining the documentation comprises:
receiving, via the spoke integration tool, a drag and drop input of the documentation, a copy and paste input of the documentation, or an upload input of the documentation.

8. The method of claim 1, wherein the documentation corresponds to a file, a database table, or a set of associations that include account information details and access details for the computing service of the external system.

9. The method of claim 1, wherein the list of actions corresponds to one or more representational state transfer (REST) steps that access the computing service and collectively define the spoke.

10. A computing system, comprising:
processing circuitry; and
a memory, accessible by the processing circuitry, and storing instructions that, when executed by the processing circuitry, cause the processing circuitry to perform operations comprising:
obtaining documentation associated with an external system, wherein the documentation comprises natural language associated with a service provided by the external system;
analyzing the documentation using one or more large language models (LLMs) to identify one or more integration points to access the service; and
generating a spoke comprising the one or more integration points, wherein the spoke is configured to enable execution of the service provided by the external system based at least in part on the one or more integration points.

11. The system of claim 10, wherein the one or more LLMs are trained on one or more business process model and notation (BPMN) conventions, one or more industry standard operating procedures, one or more best industry practices, one or more publications, or any combination thereof.

12. The system of claim 10, wherein the operations comprise:
receiving an input requesting to modify the one or more integration points;
generating updated integration points based on the input; and
generating the spoke based on the updated integration points.

13. The system of claim 12, wherein receiving the input comprises:
receiving a manual input from a spoke designer modifying the one or more integration points.

14. The system of claim 10, wherein the processing circuitry is configured to execute a cloud-based instance, the external system is external to the cloud-based instance, and wherein the cloud-based instance is configured to:
receive a request to access the service of the external system from a client device;
access the service of the external system via the spoke; and
return execution results corresponding to the request to the client device.

15. The system of claim 10, wherein the documentation corresponds to a file, a database table, or a set of associations that include account information details and access details for the service of the external system.

16. A non-transitory, computer-readable medium comprising instructions that, when executed by processing circuitry, cause the processing circuitry to perform operations comprising:
obtaining documentation associated with an external system, wherein the documentation comprises natural language associated with a service provided by the external system;
generating a list of actions based on the documentation, wherein the list of actions comprises an action to be performed to access the service;
receiving an input requesting to modify the list of actions;
generating an updated list of actions based on the input; and
generating, based on the updated list of actions, a spoke configured to enable execution of the service provided by the external system.

17. The non-transitory, computer-readable medium of claim 16, wherein the operations comprise:
prior to generating the spoke, submitting the spoke for review;
receiving approval of the updated list of actions; and
deploying the spoke based on receiving the approval.

18. The non-transitory, computer-readable medium of claim 17, wherein the processing circuitry is configured to execute a cloud-based instance that is external to the external system, and wherein the cloud-based instance is configured to facilitate connection and communication between a client device and the service of the external system via the spoke.

19. The non-transitory, computer-readable medium of claim 16, wherein the input modifying the list of actions is provided via a chat interface.

20. The non-transitory, computer-readable medium of claim 16, wherein the documentation is indicative of configuration information associated with the external system and defines an endpoint for the service, a pagination type associated with responses provided by the endpoint, mappings between descriptions of the service that appear in the responses and fields of database tables, or any combination thereof.
